(19) United States
(12) Patent Application Publication
(10) Pub. No.: US 2006/0168542 A1
(43) Pub. Date: Jul. 27, 2006

(54) Space efficient lists for thumbnails

(75) Inventors: Thamer Abanami, Seattle, WA (US); Patrick Baudisch, Seattle, WA (US); Brett Bentsen, Redmond, WA (US); Marc Doll, Seattle, WA (US); Jeff Fong, Seattle, WA (US); Julian Leonhard Selman, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/042,826

(22) Filed: Jan. 25, 2005

(51) Int. Cl. G06F 17/00; G06F 9/00

(52) U.S. Cl. 715/821; 715/823; 715/835

(57) ABSTRACT

A list of digital elements is represented by a list of graphical elements where one of the graphical elements is highlighted. The non-highlighted graphical elements are overlapped over one another based on particular overlapping heuristics.

### TECHNICAL FIELD

This invention relates to presenting digital elements in a limited display space.

### BACKGROUND

Digital elements such as music, pictures, or information may be represented by a graphical element such as a thumbnail or similar icon. The representative thumbnail or icon is displayed on a screen to a user. Typically such thumbnails are presented in a list that is displayed on the screen. The list may be presented in a vertical or horizontal order. Each thumbnail may be accompanied by descriptive information such as text. For example, accompanying text may accompany a thumbnail representative of a digital picture. A particular example of a thumbnail list is a digital music album which includes music (as represented by thumbnails) and text (describing particular songs).

A user typically navigates through a list of thumbnails by scrolling up or down in a vertical list, or scrolling left to right in a horizontal list. As the user scrolls through the list, a particular thumbnail representing a digital element is highlighted. Furthermore, text or other descriptive information may be presented to the user along with the particular thumbnail. In order to provide usability, a typical list presents preceding and succeeding thumbnails of the highlighted thumbnail along with descriptive information. In this manner the user is able to identify thumbnails in the list and their particular order in the list, and anticipate succeeding thumbnails in the list

Thumbnail lists may be presented on a display of a portable device such as a music player (e.g., an MPEG player), a personal digital assistant (PDA), or cellular phone. Since such devices are small in size, their displays are limited in size and typically cannot accommodate an entire list of graphical elements (e.g., thumbnails) at one time. Furthermore, if thumbnails are compressed in order to increase the number of thumbnails that are shown on the display, the size of the thumbnails may be too small for a user to see. Limited display size may also be a concern even for larger screens such as those used by personal computers (PC). For example, the issue of display size for PCs presents itself by constraints in user interface (UI) software that display thumbnail lists. In other words, regardless of the size of the screen, a particular UI may limit the number of thumbnails and the size of the list that may be presented to a user.

Since the display screen may be constrained in size, the number of thumbnails and descriptive information that is shown on the display screen is limited.

### SUMMARY

A computing device presents a list of graphical elements that represent digital elements. The list is presented in a graphical user interface (GUI) to a user. The graphical elements are arranged in a list where one of the graphical elements can be highlighted from the other graphical elements and the remaining graphical elements are overlapped according to defined overlapping heuristics.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

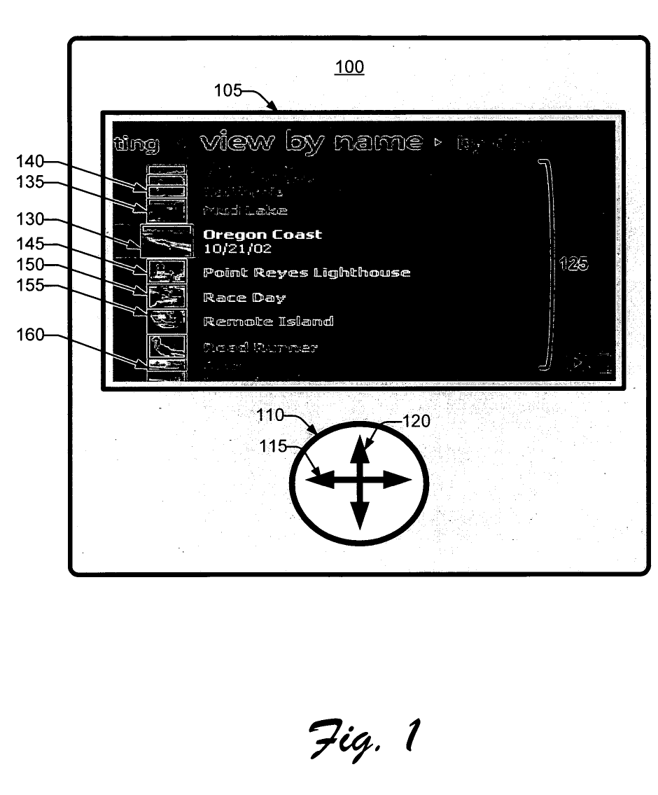

FIG. 1 is an illustration of a vertical list of thumbnails where overlap is provided to particular preceding and succeeding thumbnails of a highlighted thumbnail;

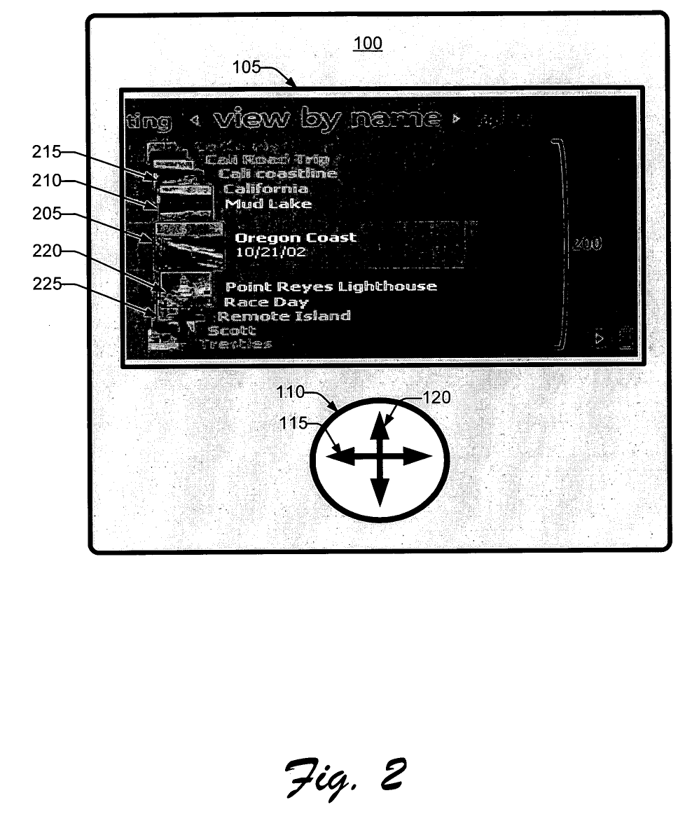

FIG. 2 is an illustration of a diagonal list of thumbnails where overlap is provided to particular preceding and succeeding thumbnails of a highlighted thumbnail;

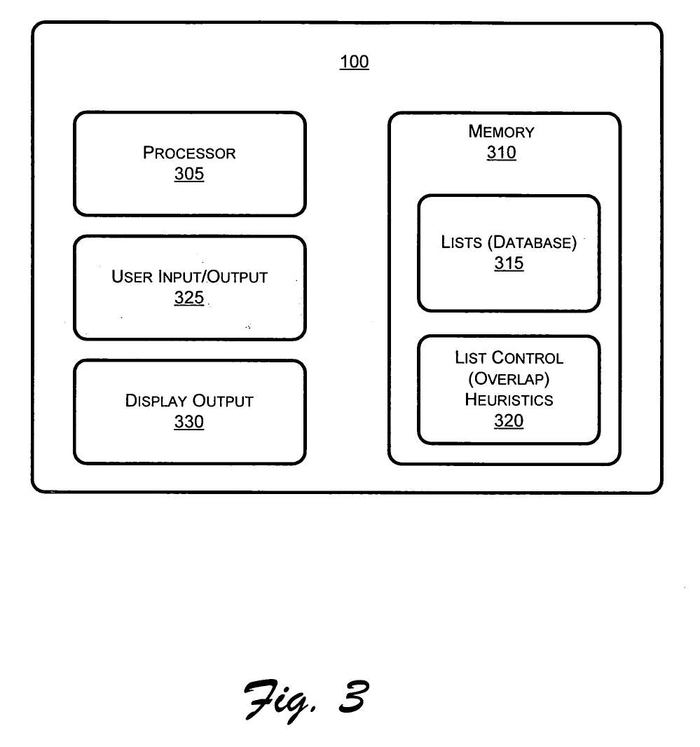

FIG. 3 is a block diagram of a computing device that provides for a list of thumbnails where particular thumbnails may be overlapped;

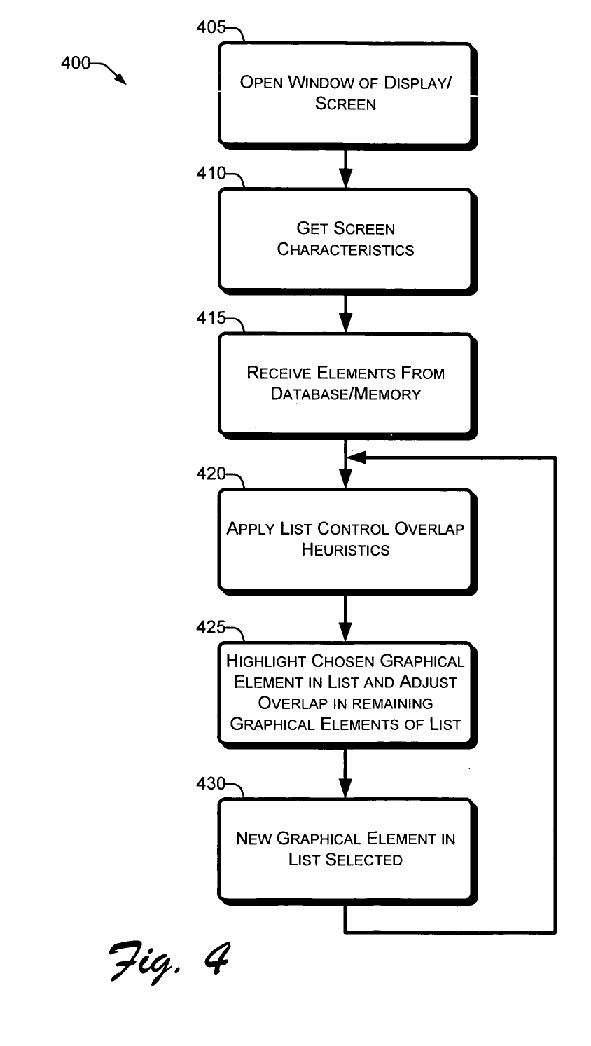

FIG. 4 is a flow diagram illustrating creating a list of overlapped thumbnails that is presented to a user; and

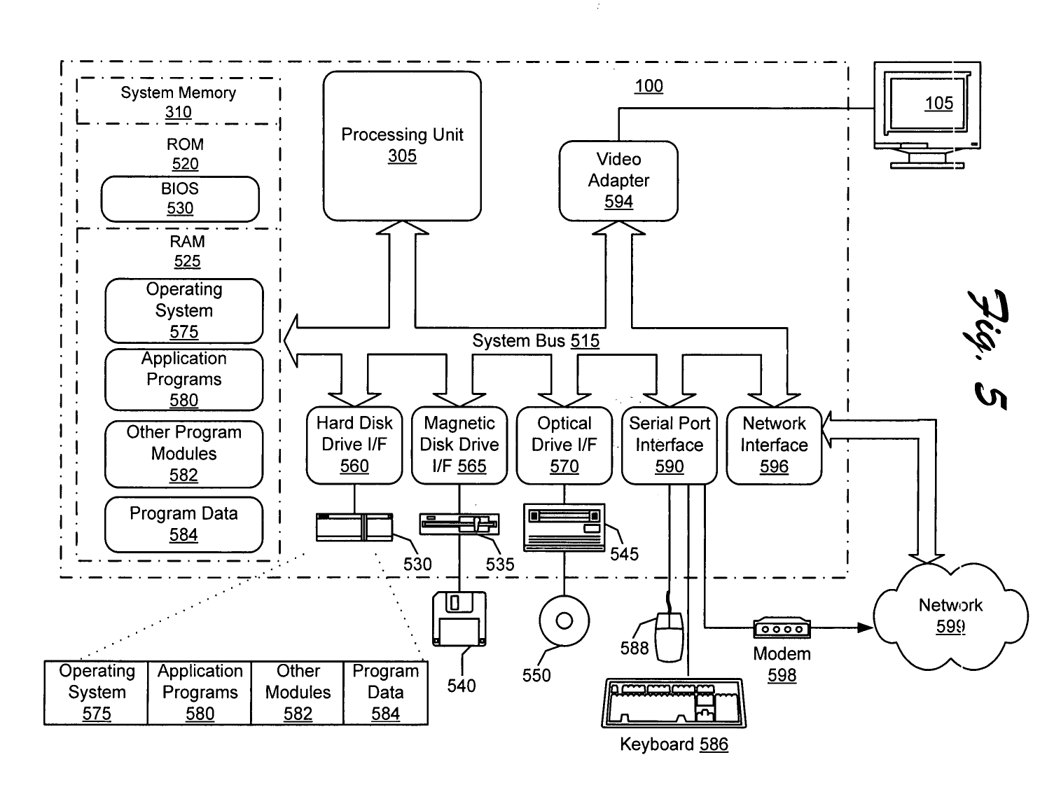

FIG. 5 is a block diagram of a detailed implementation of a computing device which provides a graphical user interface of a list of thumbnails where particular thumbnails may be overlapped.

### DETAILED DESCRIPTION

The following disclosure describes techniques in which a digital elements, and specifically thumbnails representing such digital elements, are selectively overlapped in order to more fully utilize display screen space.

FIG. 1 shows a list of thumbnails where overlap is provided to particular preceding and succeeding thumbnails of a highlighted thumbnail. A computing device 100 may be one of various devices such as a desktop personal computer (PC), a laptop PC, a tablet PC, a personal digital assistant (PDA), a music player, a portable media player, or a smart phone.

Computing device 100 includes a display 105. A user input mechanism 110 is included in computing device 100. This embodiment of the user input mechanism 110 includes a left-right input 115 and an up-down input 120. Inputs 115 & 120 allow a user to indicate scrolling by activating appropriate directional arrows on the user input mechanism 110.

In particular, the user input mechanism 110 is used to navigate or scroll through a list of thumbnails 125. The list 125 is particularly presented in a graphical user interface (GUI) to a user. The list 125 is representative of digital elements that include digital pictures, music (e.g., MPEG data), and information (e.g., contact information). Such digital elements are part of a collection and are represented as thumbnails in list 125.

In this particular example, list 125 is presented as a vertical (up-down) list; however, it is contemplated that list 125 may be presented as a horizontal (left-right) list. Other examples as discussed below include a diagonal list. Furthermore, the list 125 may be part of a grid of thumbnails wherein overlapping of thumbnails occurs vertically or horizontally in the grid. The exemplary list 125 describes a list of digital pictures of an album. A user scrolls or navigates through the list 125 using input mechanism 110, and in particularly uses up-down input 120 to scroll through the vertically presented list 125. In this example, scrolling or navigating through list 125 is performed from up to down. In other words, preceding thumbnails are at the top of list 125 and succeeding thumbnails are at the bottom of list 125. In certain cases, preceding thumbnails may be thumbnails that have been viewed (i.e., selected), and succeeding thumbnails are thumbnails that are yet to be viewed (i.e., selected).

A thumbnail representative of a particular digital element may be highlighted or selected whenever the user ceases activation of input mechanism 110. In this example, thumbnail 130 is highlighted or selected. Thumbnail 130 is a digital picture of the “Oregon Coast” that is described by text as taken on Oct. 21, 2002. The highlighted thumbnail 130 and all accompanying information (i.e., text) is fully shown to the user.

Thumbnails are not overlapped may be referred to as “bumper thumbnails” or “bumpers”. Furthermore, there may be pre-bumper thumbnails that precede a highlighted thumbnail and post-bumper thumbnails that succeed the highlighted thumbnail. A particular pre-bumper thumbnail immediately precedes the highlighted thumbnail, and a particular post-bumper immediately succeeds the highlighted thumbnail. In this example, thumbnail 135 is a pre-bumper that immediately precedes highlighted thumbnail 130. Thumbnail 140 is a preceding thumbnail to thumbnail 135. Thumbnail 145 is a post-bumper that immediately succeeds highlighted thumbnail 130. Bumper thumbnail 150 is a succeeding thumbnail to bumper thumbnail 155. In this example, a number of post-bumpers (e.g., bumpers 145, 150, and 150) are provided in order to allow a user to “preview” succeeding thumbnails. One pre-bumper (i.e., bumper 135) is provided.

In one example, thumbnails in list 125 are selectively overlapped over other thumbnails depending on their proximity to the highlighted thumbnail 150. Such overlapping utilizes the size of the display 105 and provides usability or functionality in viewing the thumbnails to a user. In general, overlapping of thumbnails takes place on thumbnails that are further in proximity from highlighted thumbnail 150. As an example, thumbnails, such as succeeding thumbnail 160, that are not proximate to highlighted thumbnail 150 are overlapped. Also, thumbnail 140 is overlapped by thumbnail 135 where thumbnail 135 is in closer in proximity to highlighted thumbnail 150. Overlapping is generally defined as covering a thumbnail (item) by other another thumbnail. Degrees of overlapping range from partially covering a thumbnail to completely covering a thumbnail. Furthermore, overlapping may take place not only for the thumbnail, but also for accompanying text or information to the thumbnail.

In this example, scrolling takes place from top to bottom. Since preceding thumbnails 135 and 140 have been viewed by a user, the degree of overlapping on preceding thumbnails may be greater than overlapping performed on succeeding thumbnails. In particular, thumbnail 135 may be completely presented to a user; however, overlapping may occur at thumbnail 140. For succeeding thumbnails the overlapping may progress less aggressively than for preceding thumbnails. In this case, succeeding thumbnails 145, 150, and 155 are not overlapped, and overlapping of succeeding thumbnails does not take place until thumbnail 160. In this manner, succeeding thumbnails may be “previewed” or anticipated by the user.

Variations in presenting the list 125 to a user include segmenting or separating the selected or highlighted thumbnail 130 from other thumbnails in the list 125. Furthermore, overlapped thumbnails and/or their accompanying text may be made smaller. Other variations in presenting list 125 include degrees of overlapping of thumbnails. Furthermore, overlapping can be determine using a suitable algorithm, mapping, or heuristically. Particular variations are further illustrated in FIG. 2.

FIG. 2 shows a diagonal list of thumbnails where overlap is provided to particular preceding and succeeding thumbnails of a highlighted thumbnail. The user input mechanism 110 is used to navigate or scroll through a list of thumbnails 200. The list 200 is particularly presented in a GUI to a user. The list 200 is representative of digital elements that include digital pictures, music (e.g., MPEG data), and information (e.g., contact information). Such digital elements are part of a collection and are represented as thumbnails in list 200.

In this example, list 200 is presented as a diagonal list, where user input mechanism 110 is used to scroll forward or scroll backward through the list 200. In particular, left-right input 115 may be used to scroll forward (i.e., activate to the right) or scroll backward (i.e., activate to the left). Alternatively, up-down, input 120 may be used to scroll forward (i.e., activate down) or to scroll backwards (i.e., activate up).

The selected or highlighted thumbnail 205 is differentiated from the other thumbnails in the list, by making it larger or offsetting or separating (i.e., segmenting) it from the other thumbnails in the list 200. In particular instances space surrounding the highlighted thumbnail 205 may be provided and further differentiating the highlighted thumbnail 205 from other thumbnails. The example further illustrates presenting a pre-bumper 210 which is slightly smaller than highlighted thumbnail 205. Bumper 210 overlaps a preceding thumbnail 215. Likewise, a post-bumper 220 is presented as slightly smaller than highlighted thumbnail 205. Bumper 220 overlaps a succeeding thumbnail 225. In this example, overlapping also occurs as to text associated with overlapped thumbnails 215 and 225. In other embodiments, text with overlapped thumbnails may be minimized (i.e., made smaller) or eliminated.

FIG. 3 shows computing device 100 in more detail. As discussed above, computing device 100 may be one of various devices such as a desktop PC, a laptop PC, a tablet PC, a PDA, a music player, a portable media player, or smart phone. An exemplary architecture of computer device 100 is further discussed in greater detail below in FIG. 5.

Computer device 100 includes a central processing unit (CPU) or processor 305 and a memory 310. In one embodiment, processor 305 accesses memory 310 through a system bus (not shown). The memory 310 includes lists or a database 315 of a collection of digital elements. The digital elements are presented in a particular order as determined in a data structure used in lists (database) 315.

Memory 310 further includes a list control heuristics module 320 that provides overlapping commands as to thumbnails of a list as shown on a display (e.g., display 105) to a user. List control heuristics module 320 includes heuristics, where heuristics may include algorithms, mapping, rules, and/or commands, directed to degrees of overlap as to thumbnails representing the digital elements included in lists (database) 315. In particular, list control heuristics module 320 defines how lists of thumbnails, such as list 125 and 200 described above, present thumbnails on a display (e.g., display 105). For example, list control heuristics module 320 applies heuristics to a displayed list of thumbnails, such as defining the degrees of overlap as to thumbnails that proceed or succeed a highlighted or selected thumbnail; and preceding and succeeding thumbnails based on their proximity to the highlighted or selected thumbnail.

Computing device 100 further includes a user input/output interface 325 that is configured to communicate with memory 310 and processor 305 access lists (database) 315. The user input/output interface 325 may also receive inputs from input mechanism 110 described above in order to scroll or navigate through the lists in lists (database) 315.

Computing device 100 includes a display output interface 330 that is configured to communicate with a display such as display 105 described above. In particular, the display output interface 330 provides a list of thumbnails that are displayed according to commands provided by list control heuristics module 320.

FIG. 4 shows a process 400 to create a list of overlapped thumbnails that is presented in a GUI to a user. The process 400 is illustrated as a collection of blocks in a logical flow graph, which represent a sequence of operations that can be implemented in hardware, software, firmware, or a combination thereof. In the context of software, the blocks represent computer instructions that, when executed by one or more processors (e.g., processor 305), perform the recited operations. The process 400 is described with reference to computing device 100 that implements the lists (database) 315 and list control heuristics 320 described above. Although described as a flowchart, it is contemplated that certain processes may take place concurrently or in a different order.

At block 405, a window of a display or screen, such as display 105, is opened. This action may be performed when a computing device (e.g., computing device 100) is turned on or activated and/or a user requests window or a user interface. The display may provide a desktop or similar interface that is shown to a user A list of thumbnails or icons representing digital elements is displayed on the desktop.

At block 410, characteristics of the screen or user interface are gotten. Characteristics include the ability of the screen or user interface to display a list of thumbnails, and particularly the number of thumbnails that can be viewed by a user. This action may be performed by the list control (overlap) heuristics module 320.

At block 415, digital elements from a data structure such as lists (database) 315 are received. Such digital elements are grouped in an ordered list as defined by the database. The database may be stored in memory such as memory 310. Thumbnails representing the fetched digital elements may be created and displayed.

At block 420, commands or heuristics are applied by a module or memory location such as list control (overlap) heuristics module 320. Such commands or heuristics describe how the thumbnails that represent the digital elements are arranged in a list of thumbnails displayed to the user. In specific, the heuristics describe how thumbnails are overlapped or not overlapped over one another. Exemplary overlapping heuristics include not overlapping adjacent thumbnails of the highlighted or selected thumbnail (i.e., digital element). Furthermore, a heuristic may be provided that overlaps particular preceding and succeeding thumbnails to the highlighted or selected thumbnail. Proximity of preceding and succeeding thumbnails to the highlighted or selected thumbnail may be a factor when determining overlapping.

At block 425, a graphical element such as a thumbnail is highlighted or selected. In specific, the user highlights or selects the thumbnail that represents a particular digital element of the list of digital elements. This action may be performed by navigating or scrolling through the list of thumbnails presented to the user. The action of selecting the thumbnail further causes the remaining thumbnails in the list to be adjusted per the heuristics as described in block 415.

At block 430, a new thumbnail (i.e., graphical element) from the list is selected by the user. The selection is performed by scrolling or navigating by the user using an input device such as input mechanism 110 described above. Once the new element is selected, block 420 is performed and a new formatted list is presented to the user.

Computing Device

FIG. 5 shows an example implementation of computing device 100 in greater detail. It will be apparent that this exemplary implementation will include components that are not used in particular architectures, and that described components may be substituted in other architectures.

The computing device 100 may be configured with a Windows® brand operating system. The computing device 100 includes processing unit or processor 305 described above, a system memory or memory 310 also described above, and a system bus 515 that interconnects various system components, including the memory 310 to the processing unit or processor 305. The system bus 515 may be implemented as any one of several bus structures and using any of a variety of bus architectures, including a memory bus or memory controller, a peripheral bus, and a local bus.

The memory 310 includes read only memory (ROM) 520 and random access memory (RAM) 525. A basic input/output system 530 (BIOS) is stored in ROM 520.

The computing device 100 has one or more of the following drives: a hard disk drive 530 for reading from and writing to a hard disk or hard disk array, a magnetic disk drive 535 for reading from or writing to a removable magnetic disk 540, and an optical disk drive 545 for reading from or writing to a removable optical disk 550 such as a CD ROM or other optical media. The hard disk drive 530, magnetic disk drive 535, and optical disk drive 545 are connected to the system bus 515 by a hard disk drive interface 560, a magnetic disk drive interface 565, and an optical drive interface 570, respectively. The drives and their associated computer-readable media provide nonvolatile storage of computer readable instructions, data structures, program modules and other data for computing device 100.

Although hard disk 530, removable magnetic disk 535, and removable optical disk 550 are described, other types of computer readable media can be used to store data. Other such media include magnetic cassettes, flash memory cards, digital video disks, Bernoulli cartridges, random access memories (RAMs), read only memories (ROMs), and the like. Additionally, the computing device 100 may be configured to serve data stored on an independent system, such as a RAID (redundant array of independent disks) storage system, particularly when implemented as a terminal server.

A number of program modules may be stored on the hard disk 530, magnetic disk 535, optical disk 550, ROM 520, or RAM 525. The programs include a server operating system 575, one or more application programs 580, other program modules 582 which include lists (database) 315 and list control heuristics 320 as described above, and program data 584.

A user may enter commands and information into the computing device 100 through input devices such as keyboard 586 and a mouse 588. Furthermore, as described above, the user may make use of input mechanism 110. Other input devices (not shown) may include a microphone, joystick, game pad, satellite dish, scanner, and the like. These and other input devices are connected to the processing unit 305 through a serial port interface 590 that is coupled to the system bus 515, but may alternatively be connected by other interfaces, such a parallel port, game port, or a universal serial bus (USB).

Display 105 or other type of display is also connected to the system bus 515 via an interface, such as a video adapter card 594 (or display output 330 as described above). The computing device 100 has a network interface or adapter 596, a modem 598 or other means for establishing communications over network 599, such as an Internet connection. The modem 598 may also facilitate connection from a protocol decoder device.

### CONCLUSION

The above-described heuristic controls and graphical user interface describe presenting lists of thumbnails representing digital elements where selected thumbnails are overlapped to utilize display space. Although the invention has been described in language specific to structural features and/or methodological acts, it is to be understood that the invention defined in the appended claims is not necessarily limited to the specific features or acts described. Rather, the specific features and acts are disclosed; as exemplary forms of implementing the claimed invention.

What is claimed is:

1. In a computing device having a graphical user interface including a display and a user input mechanism, a method of displaying a list of graphical elements comprising the steps of:
receiving digital elements, where particular graphical elements are representative of particular digital elements;
applying heuristics that determine a degree of overlap of particular graphical elements over other graphical elements; and
highlighting a chosen graphical element representative of a digital element in displaying a list of graphical elements.

2. The method of claim 1 wherein the chosen graphical element is larger than other graphical elements.

3. The method f claim 1 wherein the chosen graphical element is separated from the other graphical elements in displaying the list of graphical elements.

4. The method of claim 1 wherein the list overlap heuristics provide for greater overlap of graphical elements in the list that precedes the chosen graphical element than succeeding graphical elements of the chosen graphical element.

5. The method of claim 1 wherein the list overlap heuristics provide for text accompanying overlapped graphics elements to be made smaller than text accompanying the chosen graphical element.

6. The method of claim 1 further comprising displaying the list of the graphical elements a vertical list to a user.

7. The method of claim 1 further comprising displaying the list of the graphical elements a horizontal list to a user.

8. The method of claim 1 further comprising displaying the list of the graphical elements a diagonal list to a user.

9. The method of claim 1 further comprising displaying the list in a grid of graphical elements.

10. For use on a computing device, a storage medium having instructions that when executed on the computer, perform acts comprising:
receiving an ordered list of digital elements, where each digital element is represented by a particular graphical element;
arranging graphical elements representing the digital elements in a graphical element list presented to a user;
highlighting a particular graphical element of the graphical elements of the graphical element list: and
overlapping non-highlighted graphical elements in the list.

11. A storage medium as recited in claim 10 wherein the arranging the graphical elements is selected from one of the following lists: a vertical list, a horizontal list, or a diagonal list.

12. A storage medium as recited in claim 10 wherein the highlighting comprises segmenting the particular graphical element from the other graphical elements of the list.

13. A storage medium as recited in claim 10 wherein the highlighting comprises displaying the particular graphical element larger than the other graphical elements of the list.

14. A storage medium as recited in claim 10 wherein the overlapping is dependent on the proximity of the non-highlighted graphical elements to the highlighted graphical element.

15. A storage medium as recited in claim 10 wherein the overlapping provides for text accompanying non-highlighted graphical elements to be smaller than text accompanying the highlighted graphical element.

16. A method comprising:
receiving an ordered list of digital elements where each digital element is represented by graphical element;
presenting the graphical elements representing the digital elements in a list displayed to a user;
selecting one of the graphical elements in response to an input by a user; and
overlapping graphical elements that are not selected.

17. The method of claim 16 wherein the presenting is selected from one of the following lists: a vertical list, a horizontal list, or a diagonal list.

18. The method of claim 16 wherein the selecting comprises highlighting the one of the graphical elements.

19. The method of claim 16 wherein immediately preceding and immediately succeeding graphical elements of the selected graphical element are not overlapped.

20. The method of claim 16 wherein the overlapping is dependent on the proximity of the non-selected graphical elements to the selected graphical element.
